(19) United States
(12) Patent Application Publication
(10) Pub. No.: US 2026/0121728 A1
(43) Pub. Date: Apr. 30, 2026

(54) LOW COMPLEXITY BEAMFORMING

(71) Applicant: Nokia Solutions and Networks Oy, Espoo (FI)

(72) Inventors: Nuan SONG, Shanghai (CN); Stefan WESEMANN, Stuttgart (DE); Olli Juhani PIIRAINEN, Oulu (FI); Tao YANG, Shanghai (CN); Yan ZHAO, Shanghai (CN)

(21) Appl. No.: 19/473,959

(22) PCT Filed: Apr. 14, 2023
(86) PCT No.: PCT/CN2023/088527

§ 371 Date: Oct. 9, 2025

(51) Int. Cl. H04B 7/06

(52) U.S. Cl. CPC H04B 7/06952; H04B 7/0617

(57) ABSTRACT

The present embodiments disclose devices, methods, apparatuses and computer readable storage media of low complexity beamforming. The method comprises determining, at a network device, a channel covariance matrix and at least one signature vector, the at least one signature vector characterizing features of a signal associated with the terminal device; constructing one or more beam sets based on the channel covariance matrix and the at least one signature vector; selecting a predefined number of beams from the one or more beam sets; and performing a transmission to the terminal device based on a target beamforming matrix determined at least based on the predefined number of beams.

### FIELD

Embodiments of the present disclosure generally relate to the field of telecommunication and in particular to devices, methods, apparatuses and computer readable storage media of low complexity beamforming.

### BACKGROUND

Massive Multiple Input Multiple Output (MIMO) combined with beamforming may deliver a high spatial multiplexing gain and a large beamforming gain. It is considered as one key feature of 5th Generation Mobile Communication Technology (5G) New Radio (NR) to enhance the system spectral efficiency. The 6th Generation Mobile Communication Technology (6G) radio may provide an even higher capacity to support a large number of users.

### SUMMARY

In a first aspect, there is provided an apparatus. The apparatus includes at least one processor; and at least one memory storing instructions that, when executed by the at least one processor, cause the apparatus at least to: determine a channel covariance matrix and at least one signature vector, the at least one signature vector characterizing features of a signal associated with the terminal device; construct one or more beam sets based on the channel covariance matrix and the at least one signature vector; select a predefined number of beams from the one or more beam sets; and perform a transmission to the terminal device based on a target beamforming matrix determined at least based on the predefined number of beams.

In a second aspect, there is provided an apparatus. The apparatus includes at least one processor; and at least one memory storing instructions that, when executed by the at least one processor, cause the apparatus at least to receive a transmission from a network device by using a target beamforming matrix, wherein the target beamforming matrix is determined at least based on a predefined number of beams selected from one or more beam sets constructed based on a channel covariance matrix and at least one signature vector, and wherein the at least one signature vector characterizes features of a signal associated with the apparatus.

In a third aspect, there is provide a method. The method comprises determining, at a network device, a channel covariance matrix and at least one signature vector, the at least one signature vector characterizing features of a signal associated with the terminal device; constructing one or more beam sets based on the channel covariance matrix and the at least one signature vector; selecting a predefined number of beams from the one or more beam sets; and performing a transmission to the terminal device based on a target beamforming matrix determined at least based on the predefined number of beams.

In a fourth aspect, there is provide a method. The method comprises receiving, at a terminal device, a transmission from a network device by using a target beamforming matrix, wherein the target beamforming matrix is determined at least based on a predefined number of beams selected from one or more beam sets constructed based on a channel covariance matrix and at least one signature vector, and wherein the at least one signature vector characterizes features of a signal associated with the terminal device.

In a fifth aspect, there is provided an apparatus comprising means for determining a channel covariance matrix and at least one signature vector, the at least one signature vector characterizing features of a signal associated with the terminal device; means for constructing one or more beam sets based on the channel covariance matrix and the at least one signature vector; means for selecting a predefined number of beams from the one or more beam sets; and means for performing a transmission to the terminal device based on a target beamforming matrix determined at least based on the predefined number of beams.

In a sixth aspect, there is provided an apparatus comprising means for receiving a transmission from a network device by using a target beamforming matrix, wherein the target beamforming matrix is determined at least based on a predefined number of beams selected from one or more beam sets constructed based on a channel covariance matrix and at least one signature vector, and wherein the at least one signature vector characterizes features of a signal associated with the apparatus.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of low complexity beamforming according to some example embodiments of the present disclosure;

FIG. 3 shows an example of the criterion to determine the beamforming implementation mode according to some example embodiments of the present disclosure;

FIGS. 4A-4D show the spectral efficiency performance of various wideband beamforming schemes according to some example embodiments of the present disclosure;

FIG. 5 shows a simulation result of the spectral performance of difference subband beamforming schemes according to some example embodiments of the present disclosure;

FIGS. 6A-6C show computational complexity for different schemes using different sizes of the matrix according to some example embodiments of the present disclosure;

FIG. 7 shows a flowchart of an example method of low complexity beamforming according to some example embodiments of the present disclosure;

FIG. 8 shows a flowchart of an example method of low complexity beamforming according to some example embodiments of the present disclosure;

FIG. 9 shows a simplified block diagram of a device that is suitable for implementing example embodiments of the present disclosure; and

FIG. 10 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment is includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication is network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

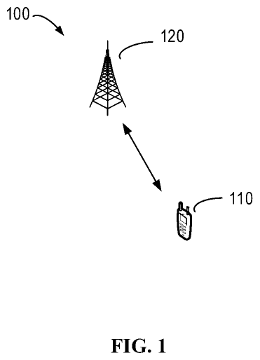

FIG. 1 shows an example communication network 100 in which embodiments of the present disclosure may be implemented. As shown in FIG. 1, the communication network 100 may include a terminal device 110. Hereinafter the terminal device 110 may also be referred to as a UE.

The communication network 100 may further include a network device 120. Hereinafter the network device 120 may also be referred to as a gNB. The terminal device 110 may communicate with the network device 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As described above, the 6G radio should provide an even higher capacity to support a large number of users. For example, the mid-band spectrum (7 GHz˜20 GHz) may be combined with extreme massive MIMO antenna arrays with up to 1024TRXs and larger antenna arrays at the terminal devices may provide around 20×more capacity compared to 5G.

During a typical implementation for transmit processing, the beamforming may act as reduced-rank filtering to reduce the overhead of the Channel State Information (CSI) feedback, to enhance the array gain, and to lower the complexity of precoding. Low-complexity beamforming solutions for massive MIMO are still desired for 5G/6G massive MIMO products.

Eigen Beamforming (EBF) relies on Eigen-Value Decomposition (EVD), whose computational complexity scales with the array dimension, i.e., in the order of O(N³) with N being the size of the array related matrix used for calculating EVD. As a much larger number of TRXs are required in the system, e.g., greater than 128, the computational efforts and the complexity of using EBF may become extremely huge and cannot be afforded.

Thus, a more flexible procedure to carry out low-complexity beamforming schemes may be expected, which may provide an enhanced performance but with simple implementations on the Field Programmable Gate Array (FPGA)/System on Chip (SoC).

According to some example embodiments of the present disclosure, there is provided a solution for low complexity beamforming. In the solution, the network device 120 determines a channel covariance matrix and at least one signature vector transmitted from the terminal device 110 and constructs one or more beam sets based on the channel covariance matrix and the at least one signature vector. The network device 120 then selects a predefined number of beams from the one or more beam sets and perform a transmission to the terminal device based on a target beamforming matrix determined at least based on the predefined number of beams.

Example embodiments of the present disclosure will be described in detail below with reference to the accompanying drawings.

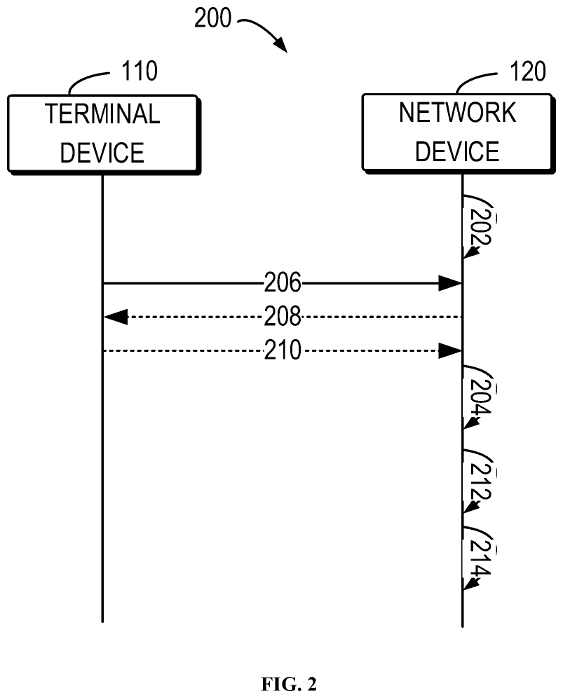

Reference is now made to FIG. 2, which shows a signaling chart 200 for communication according to some example embodiments of the present disclosure. As shown in FIG. 2, the signaling chart 200 involves a terminal device 110 and a network device 120. For the purpose of discussion, reference is made to FIG. 1 to describe the signaling chart 200. Although a single terminal device 110 is illustrated in FIG. 2, it would be appreciated that there may be a plurality of terminal devices performing similar operations as described with respect to the terminal device 110 below.

The process as shown in FIG. 2 may adopt three modes to obtain at least one signature vector, which may characterize features of a signal associated with the terminal device 110. Specifically, the signature vector may represent the vector that may characterize essential features in the signal to/from/associated with the terminal device 110 of interest (for example, spatial feature, code feature, etc and whose design and acquisition is one of the most essential problems in the proposed beamforming algorithm.

The three modes may comprise a UE-specific procedure, during which the network device may determine the at least one signature vector based on a Sounding Reference Signal (SRS) transmitted from the terminal device; a cell-specific procedure, during which the network device may determine the at least one signature vector based on the beam feedback from terminal device 110 determined by receiving and measuring the Synchronization Signal Block (SSB) and/or Channel State Information Reference Signal (CSI-RS) from the network device 120; and a combination mode by using both the UE-specific procedure and the cell-specific procedure as described above.

As shown in FIG. 2, the network device 120 may determine (202) which mode is to be used for determining the at least one signature vector.

For example, the determination criterion may depend on capabilities of terminal device 110, such as whether the terminal device 110 is able to feedback grid-of-beam (GoB) beams in time or whether the terminal device 110 has asymmetric transmit/receive Radio Reference (RF) frontends (e.g., different number of transmit and receive antennas).

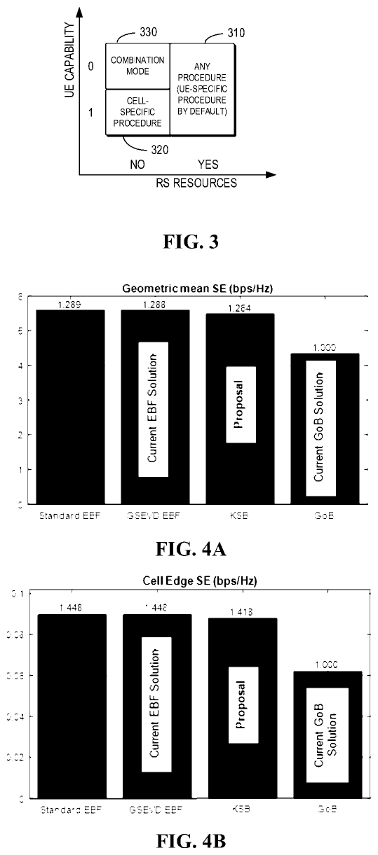

FIG. 3 shows an example of the criterion to determine the beamforming implementation mode according to some example embodiments of the present disclosure. As shown, the capability value “0” means the terminal device 110 has no such capabilities and the capability value “1” means the terminal device 110 has such capabilities. Furthermore, there may exist limited reference signal (RS) resources to serve a large number of terminal devices simultaneously, e.g., pilot contamination. The RS resources indicating “Yes” means the RS resources are sufficient and indicating “No” means the RS resources are insufficient. When there are insufficient RS resources, it is suggested that the number of signature vectors should be K>1 and the cell-specific procedure 320 or the combination mode 330 may be considered, depending on whether the terminal device 110 has related capabilities or not, respectively. When there are enough RS resources, any procedure could be applied (e.g., default by the UE-specific procedure 310 if no configuration is indicated from the network device 120).

Referring back to FIG. 2, the network device 120 may determine (204) a channel covariance matrix and the at least one signature vector.

The network device 120 may determine the channel covariance matrix based on an SRS received (206) from the terminal device 110. For example, the channel covariance matrix R can be calculated at the network device 120 based on measurements on the SRS by the equation (1) as below:

$$R = \frac{1}{{N}_{t} {N}_{f} {N}_{pol}} {\sum }_{{n}_{t} = 1}^{{N}_{t}} {\sum }_{{n}_{f} = 1}^{{N}_{f}} {\sum }_{{n}_{p} = 1}^{{N}_{pol}} {H}^{H} ( {n}_{t} , {n}_{f} , {n}_{p} ) H ( {n}_{t} , {n}_{f} , {n}_{p} ) \qquad ( 1 )$$

where H(nₜ, n_{f}, nₚ) ∈C^{M}^{ᵣ}^{×M}^{ₜ} is the channel between the terminal device 110 with Mr antennas and the network device 120 with M_{T}=MₜNnₚₒₗ antennas at the time slot nₜ, the frequency carrier n_{f}, and the nₚ-th polarization.

Then the network device 120 may determine the at least one signature vector at least one the determined mode, i.e., the UE-specific procedure, the cell-specific procedure or the combination mode as described above. That is, the network device 120 may determine the at least one signature vector based on the SRS measurement and/or beam feedback received from the terminal device 110. The terminal device 110 may provide (210) the beam feedback based on a measurement on SSB and/or CSI-RS transmitted (208) from the network device 120 to the terminal device 110.

Furthermore, the determination of the at least one signature vector may also comprise a determination on the number of signature vector(s) and/or a determination of respective one or more weights of at least one signature vector.

In a case where at least one channel signature vector aₖ, k=1, . . . , K, K≥1, and the number of signature vectors K and the respective weights are to be determined, as an option, the number of signature vectors K can be determined from the uplink SRS measurements. In this case, two implementation solutions may be adopted.

In one implementation solution, which may be referred to as an Angular Power Spectrum (APS) based solution, the network device 120 may estimate the channel covariance matrix R from the SRS using the equation (1) and construct the APS. It extracts K dominant peaks from APS that correspond to K dominant angles &k, k=1, . . . , K, K≥1, where K can be simply or heuristically determined by comparing the APS value with a certain threshold. For example, if the APS is denoted by ρ(θ), the dominant (multiple) angle(s) θₖ can be obtained by determining the angles corresponding to K peak(s) of the APS|ρ(θ)|. The determination of peak(s) is carried out according to:

$${θ}_{k} : peak ( \vert ρ ( θ ) \vert ) > {γ}_{th} \cdot \vert ρ ( {θ}_{max} ) \vert , ∀ θ \qquad ( 2 )$$

where γth can be chosen such as γ=0.5 and |ρ(θₘₐₓ)| corresponds to the strongest peak.

The signature vectors then can be obtained as the array responses in the direction of σₖ, i.e., aₖ=b(θₖ), where b(θ) denotes the array response of the network device 120 at angle θ.

In another implementation solution, which may be referred to as a codebook-based solution, the network device 120 may estimate the channel covariance matrix R from the SRS using the equation (1) and select K beams from the pre-defined codebook. For example, K dominant beams can be selected using the GoB concept, by:

$${a}_{k} = {max}_{∀ j} \{ {c}_{j}^{H} {Rc}_{j} \} , k = 1 , … , K \qquad ( 3 )$$

where cⱼ is the J-th column of the codebook C∈C^{M}^{ₜ}^{×N} with N indicating the size/resolution of the codebook. Thus, the signature vector can be obtained by aₖ=cₖ.

As another option, the number of signature vectors K can be determined by using beam feedback from the terminal device 110. In this case, the number of signature vectors K can also be determined from the available beam feedback. For example if the terminal device 110 feeds back 2 downlink GoB beams, the network device 120 may determine whether 1 beam or 2 beams are considered as the signature vector(s).

It is also possible that the number of signature vectors K can be determined based on the combination mode, i.e., based on both available beam feedback and the SRS measurement by using implementation solutions as described above.

Then the network device 120 may further construct (212) one or more beam sets based on the channel covariance matrix and the at least one signature vector.

For example, for each signature vector k, the network device 120 may construct a beam set k, using the following calculations. Specifically, the network device 120 may subsequently calculate on the basis vectors w_{k,i} of the beamforming matrix, using the channel covariance matrix R and the signature vector by:

$${w}_{k , i} = \frac{{Rw}_{k , i - 1}}{{‖ {Rw}_{k , i - 1} ‖}_{2}} with {w}_{k , 0} = \frac{{a}_{k}}{{‖ {a}_{k} ‖}_{2}} \qquad ( 4 )$$

The network device 120 may determine the number of beam basis vectors in a beam set k by calculating the correlation between consecutive basis vectors. For example, the order rₖ of a constructed beamforming matrix (i.e., a constructed beam set) may be determined based on comparing the Euclidean or Chordal distance between two adjacent beamforming basis vectors. The number of basis vectors rₖ should not be less than the predefined number of beams D, i.e., rₖ≥D.

For example, the order selection according to the Euclidean distance may be obtained based on equation (5) as below, where the scalar P is a small threshold:

$${‖ {w}_{k , i} - {w}_{k , i - 1} ‖}_{2} > μ \qquad ( 5 )$$

Alternatively, Chordal distance could be used as the criterion, which can be represented by:

$$1 - \frac{{‖ {w}_{k , i - 1} - {w}_{k , i} ‖}_{2}}{{‖ {w}_{k , i - 1} ‖}_{2} {‖ {w}_{k , i} ‖}_{2}} > μ \qquad ( 6 )$$

Then the network device 120 may determine a beam set k with rₖ basis vectors according to:

$${W}_{k} = [ {w}_{k , 0} , {w}_{k , 1} , … {w}_{k , {r}_{k} - 1} ] . \qquad ( 7 )$$

From the constructed one or more beam sets, the network device 120 may select (214) a predefined number of beams, to construct a new beam set.

In some example embodiments, the network device 120 may select D beams from K constructed beam sets, depending on the number of beam sets or the number of signature vectors K, and obtains the beam set W̅_{D}.

Regardless of one signature vector or multiple signature vectors, to ensure a good beamforming gain, the general criterion is that to choose the vectors representing higher powers of the channel covariance matrix R, and therefore the original signature vector should not be selected.

For example, if only one beam set is constructed, the network device 120 may select beams from this beam set, to construct the new beam set, according to the higher powers of channel covariance matrix R criterion. For example, if K=1, D beams are selected from the constructed beam set W₁=[w_{1,0}, w_{1,1}, . . . , w_{1,r}_{₁}₋₁]. The criterion is to choose the vectors with a higher power for the channel covariance matrix R. In this case, the last D column vectors, denoted by W̅_{D}=W₁(:, r₁−D+1: r₁)=[w_{1,r}_{₁}_{-D}, . . . , W_{1,r}_{₁}₋₁], are chosen.

If more than one beam sets are constructed, the network device 120 may select beams from the concatenation of the more than one beam sets according to the joint criterion of the importance of the signature vectors and higher powers of channel covariance matrix R. For example, if K>1, the total beam set is obtained by concatenating K original beam sets, i.e., W=[W₁, . . . W_{K}]. For beam selection, the following cases may be considered.

As an option, if K=D, for example, if 2 signature vectors (K=D=2) are determined, the column vectors including [w_{1,r}_{₁}₋₁, w_{2,r}_{₂}₋₁] are chosen.

As another option, if K<D, for example, if K=2 and D=4, the beams [w_{1,r}_{₁}₋₂, w_{1,r}_{₁}₋₁, w_{2,r}_{₂}₋₂, w₂ᵣ_{₂}₋₁] are considered.

After the new beam set is determine, the network device 120 may perform a transmission to the terminal device based on a beamforming matrix determined at least based on the predefined number of beams of the new beam set.

An example of a process of beamforming algorithm as proposed above may be listed as below:

TABLE 1
Proposed beamforming algorithm

```
Require: signature vector aₖ, k ≥ 1, channel covariance matrix R, number of beams D
Output: beamforming matrix W_{D}
For k = 1, ... , K
$Initialize {w}_{k , 0} = \frac{{a}_{k}}{{‖ {a}_{k} ‖}_{2}} , i = 1 , {W}_{k} : empty matrix , μ is a small scalar$
                  ${w}_{k . i} = \frac{{Rw}_{k , i - 1}}{{‖ {Rw}_{k , i - 1} ‖}_{2}}$
                While ||w_{k,i} − w_{k,i-1}||₂ > μ or rₖ < D
                    Wₖ = ┌Wₖ|w_{k,i}┐, i = i + 1, rₖ = i
                  End
End k
    W̅_{D}: Select D vectors from original beam set W = [W₁, ... , W_{K}]
    W_{D} = GramSchmidt(W̅_{D})
End
```

Alternatively or optionally, the network device 120 may further refine the constructed new beam set. For example, the network device 120 may update the new beam set via orthogonalization of the refined beamforming matrix WD and obtains the updated beamforming matrix WD. For example, the popular Gram-Schmidt orthogonalization can be carried out and the corresponding process is shown in Table 2 with the inputs of beamforming matrix and the number of beamforming vectors.

TABLE 2
Gram-Schmidt orthogonalization procedure

| | |
|---|---|
| 1 | function Q = gramSchmidt(A, numVectors) |
| 2 | if nargin == 1, numVectors = size(A, 1); end |
| 3 | numVectors = min( [ size(A,1) numVectors ] ); |
| 4 | Q = zeros(size(A,1), numVectors); |
| 5 | u = zeros(size(A,1), numVectors); |
| 6 | for k = 1 : numVectors |
| 7 | for d = 1 : k − 1 |
| 8 | u(:, k) = u(:, k) + u(:, d)′ * A(:, k) / (u(:, d)′ * u(:, d)) * u(:, |
| | d); |
| 9 | end |
| 10 | u(:, k) = A(:, k) − u(:, k); |
| 11 | Q(:, k) = u(:, k) / norm(u(:, k)); |
| 12 | end |
| 13 | end |

In the solution of the present disclosure, different beamforming implementation modes are supported, based on the system configuration. More than one signature vector (can be two or more) can be considered, which are determined according to configured beamforming implementation modes. Furthermore, more beams than required based on distance criterion can be determined and beams among the original beamforming sets can be selected.

Moreover, compared to the current EBF solutions, which mainly focus on different low-complexity implementations of EVD itself and the EBF beamforming procedure can only be based on UE-specific SRS measurements, the solution of the present disclosure proposes a higher flexibility to implement beamforming, using either SRS based or combined with cell-specific SSB/CSI-RS based. The beamforming calculation does not utilize any EVD implementations and can be considered as a more practical alternative solution to EBF and a much enhanced one to GoB. The present disclosure may compute a beamforming matrix whose vectors are different from the eigenvectors. Eigenvector based signature vector should not be chosen in the algorithm of the present disclosure due to fast convergence to itself in the subspace.

By using multiple signature vectors in rich scattered channels, the calculation of the powers of the channel covariance matrix can be reduced and meantime a better performance can be achieved. Further, using multiple signature vectors and the proposed beam selection criterion may help to avoid numerical problems in certain orthogonalization procedure.

Additionally, a lower computational complexity may be achieved because no iterations are needed. using either purely UE-specific procedure or with assistance of cell-specific procedure to generate beamforming vectors may lead to a higher flexibility. Meanwhile, the proposed beam selection criterion may be crucial for the parameterization of stable beamforming solutions.

Some simulations are made in different scenarios for evaluating the performance of the solution proposed in the present disclosure.

For example, the performance of the proposed scheme for the wideband beamforming function can be evaluated and compared with different reference methods, where zero-forcing precoding is considered for all the cases. The “Standard EBF” is the upper bound solution, using standard EVD to calculate eigen beams. The “GoB” is the current GoB based MIMO solution based on the DFT codebook with an oversampling factor 4. The “GSEVD EBF” is a variant of the power iterative EVD method for multi-beam calculations, where the number of iterations of 4 is chosen. The “KSB” refers to the proposed solution where the signature vector is obtained by choosing the beam according to equation (4) from the DFT codebook with an oversampling factor 4. The channel parameters as well as the array geometry used are listed in Table 3.

TABLE 3
Simulation setup for wideband beamforming
Simulation Parameters

| | |
|---|---|
| Channel model | sub-6GHz in 3GPP TR 38.901 |
| Scenario | NR-Umi/Uma |
| Carrier frequency (DL) | 2.15 GHz |
| Bandwidth | 20 MHz |
| BS Tx Antenna | 192 AEs (12 × 8 × 2)→ 64 TXRUs (4 × 8 × 2) |
| UE Rx Antenna | 2 AEs ports (1 × 1 × 2) |
| # of streams | 2-layer transmission |

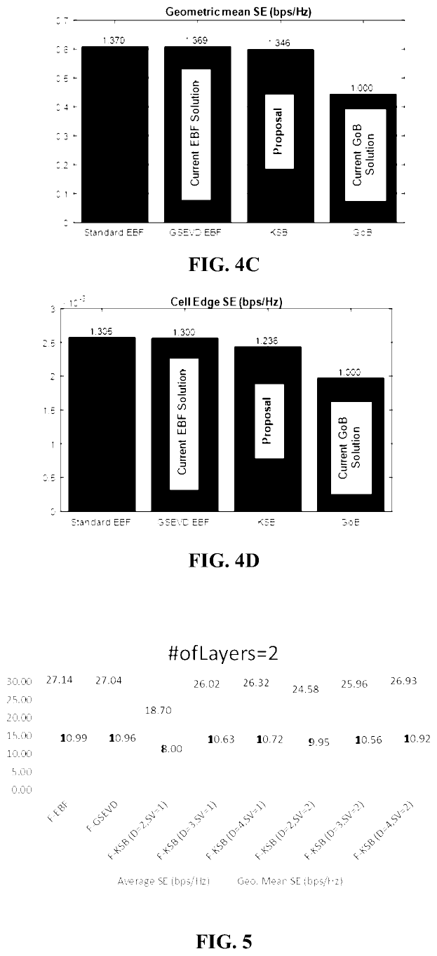

FIGS. 4A-4D show the spectral efficiency performance of various wideband beamforming schemes according to some example embodiments of the present disclosure. As shown in FIGS. 4A-4D, in both Uma and Umi scenarios, the KSB and the EBF methods significantly outperform the GoB method by 20%˜40% gain. The low-complexity GSEVD EBF performs closely to the standard EBF and the proposed KSB has only <2% performance loss as compared to the standard EBF.

Furthermore, the performance of the proposed algorithm in the subband beamforming scenario may also be evaluated. Simulation details are shown in Table 4. Different from the wideband case, the one-stage subband beamforming may be considered to map the data streams to 64 TXRUs directly in the frequency selective manner. The “F-EBF” and “F-GSEVD” schemes refer to the full EBF using standard EVD and power iterative EVD, respectively. In the proposed “F-KSB” algorithms, “SV” is short for signature vector and D is related to the number of selected beams as well as the order of the channel covariance matrix.

TABLE 4
Simulation setup for subband beamforming
Simulation Parameters

| | |
|---|---|
| Channel model | sub-6GHz in 3GPP TR 38.901 |
| Scenario | NR-Umi |
| Carrier frequency (DL) | 2.15 GHz |
| Bandwidth | 20 MHz |
| BS Tx Antenna | 192 AEs (12 × 8 × 2)→ 64 TXRUs (4 × 8 × 2) |
| UE Rx Antenna | 4 AEs ports (1 × 2 × 2) |
| # of streams | Max 4-layer transmission |

FIG. 5 shows a simulation result of the spectral performance of difference subband beamforming schemes according to some example embodiments of the present disclosure. It can be observed that using higher orders of the channel covariance matrix and multiple signature vectors helps for the case with a limited number of beams (as compared to channel rank), especially advantageous for rich scattered channels. It can also trades-off the performance by using smaller orders with a lower complexity.

The computational complexity of the proposed subspace method may come from a construction of the beamforming matrix in equation (1) and the orthogonalization. The computational complexity refers to the number of complex multiplications, and the number of complex additions is trivial and thus neglected. Denoting the number of beamforming vectors as r, the matrix dimension as N, and the number of iterations for the power iterative based EVD as J, the computational complexity for the proposed KSB in constructing the beamforming matrix is (r−1)N² and the Gram-Schmidt orthogonalization for r beamforming vectors costs

$$\frac{3 N ( r - 1 ) r}{2} + 2 rN .$$

The complexity calculation for different schemes is shown as below, where the Gradient Ascent and GSEVD methods are included for comparison.

TABLE 5
Computational complexity for different schemes

| | Computational Complexity (# of complex multiplications) |
|---|---|
| Gradient Ascent | C_{GA} = (rJ + 2r − 1)N² + 10rJN + 2rJ |
| GSEVD | ${C}_{GSEVD} = \frac{3 N ( r - 1 ) r}{2} + 2 rN + {JrN}^{2} + J ( \frac{3 N ( r - 1 ) r}{2} + 2 rN )$ |
| KSB | ${C}_{KSB} = ( r - 1 ) {N}^{2} + ( \frac{3 N ( r - 1 ) r}{2} + 2 r N )$ |

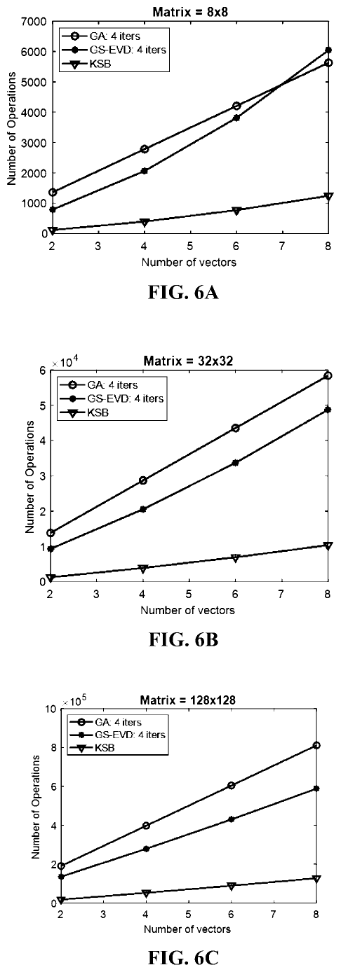

FIGS. 6A-6C show computational complexity for different schemes using different sizes of the matrix according to some example embodiments of the present disclosure, which depict the computational complexity curves of different schemes as a function of the number of beamforming vectors, where the iteration number for GA and GSEVD is fixed as 4. It can be observed that the KSB has a much lower computational complexity, only needs 12%˜18% complexity of GSEVD and 8%˜13% of GA.

Therefore, it can be concluded that the proposed KSB algorithm is able to approach the standard EBF performance with <2% loss while has a much lower implementation complexity (i.e., 80%˜90% complexity reduction) as compared to the MN's EBF variants.

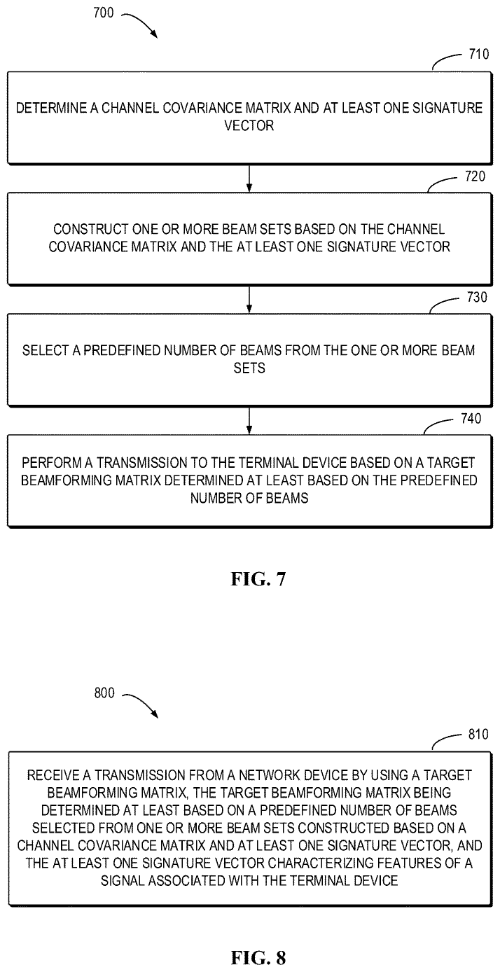

FIG. 7 shows a flowchart of an example method 700 for the low complexity beamforming according to some example embodiments of the present disclosure. The method 700 may be implemented at the network device 120 as shown in FIG. 1. For the purpose of discussion, the method 700 will be described with reference to FIG. 1.

At 710, the network device 120 determines a channel covariance matrix and at least one signature vector. The at least one signature vector characterizing features of a signal associated with the terminal device.

At 720, the network device 120 constructs one or more beam sets based on the channel covariance matrix and the at least one signature vector.

At 730, the network device 120 selects a predefined number of beams from the one or more beam sets.

At 740, the network device 120 performs a transmission to the terminal device based on a target beamforming matrix determined at least based on the predefined number of beams.

In some example embodiments, the network device 120 may determine a mode for determining the at least one signature vector based on at least one of whether the terminal device is able to feedback GoB beams in time; or whether reference signal resources are sufficient.

In some example embodiments, the network device 120 may determine the channel covariance matrix based on a sounding reference signal transmitted from the terminal device; and determine the at least one signature vector based on at least one of: an SRS transmitted from the terminal device; or beam feedback determined by the terminal device based on a detection of a SSB or a CSI-RS transmitted from the network device.

In some example embodiments, the number of one or more beam sets is associated with the number of determined at least one signature vector.

In some example embodiments, the number of basis vectors comprised in the one or more beam sets equals to or is more than the predefined number of beams.

In some example embodiments, the network device 120 may determine beamforming basis vectors comprised in the one or more beam sets based on a Euclidean or a Chordal distance between two adjacent beamforming basis vectors.

In some example embodiments, the network device 120 may select the predefined number of beams from the one or more beam sets based on respective powers of the channel covariance matrix represented by beamforming basis vectors comprised in the one or more beam sets.

In some example embodiments, the network device 120 may determine an initial beamforming matrix based on the predefined number of beams; and determine a target beamforming matrix by an orthogonalization of beamforming vectors in the initial beamforming matrix.

FIG. 8 shows a flowchart of an example method 800 of the low complexity beamforming according to some example embodiments of the present disclosure. The method 800 may be implemented at the terminal device 110 shown in FIG. 1. For the purpose of discussion, the method 800 will be described with reference to FIG. 1.

At 810, the terminal device 110 receives a transmission from a network device by using a target beamforming matrix, wherein the target beamforming matrix is determined at least based on a predefined number of beams selected from one or more beam sets constructed based on a channel covariance matrix and at least one signature vector, and wherein the at least one signature vector characterizes features of a signal associated with the terminal device.

In some example embodiments, the terminal device 110 may transmit an SRS to the network device.

In some example embodiments, the terminal device 110 may receive a SSB or a CSI-RS from the network device; and transmit, to the network device, beam feedback determined based on a detection of the SSB or the CSI-RS.

In some example embodiments, an apparatus capable of performing the method 700 (for example, implemented at the network device 120) may include means for performing the respective steps of the method 700. The means may be implemented in any suitable form. For example, the means may be implemented in a circuitry or software module.

In some example embodiments, the apparatus comprises means for determining a channel covariance matrix and at least one signature vector, the at least one signature vector characterizing features of a signal associated with the terminal device; means for constructing one or more beam sets based on the channel covariance matrix and the at least one signature vector; means for selecting a predefined number of beams from the one or more beam sets; and means for performing a transmission to the terminal device based on a target beamforming matrix determined at least based on the predefined number of beams.

In some example embodiments, the apparatus further comprises means for determining a mode for determining the at least one signature vector based on at least one of whether the terminal device is able to feedback GoB beams in time; or whether reference signal resources are sufficient.

In some example embodiments, the apparatus further comprises means for determining the channel covariance matrix based on a sounding reference signal transmitted from the terminal device; and means for determining the at least one signature vector based on at least one of: an SRS transmitted from the terminal device; or beam feedback determined by the terminal device based on a detection of a SSB or a CSI-RS transmitted from the apparatus.

In some example embodiments, the number of one or more beam sets is associated with the number of determined at least one signature vector.

In some example embodiments, the number of basis vectors comprised in the one or more beam sets equals to or is more than the predefined number of beams.

In some example embodiments, the apparatus further comprises means for determining beamforming basis vectors comprised in the one or more beam sets based on a Euclidean or a Chordal distance between two adjacent beamforming basis vectors.

In some example embodiments, the apparatus further comprises means for selecting the predefined number of beams from the one or more beam sets based on respective powers of the channel covariance matrix represented by beamforming basis vectors comprised in the one or more beam sets.

In some example embodiments, the apparatus further comprises means for determining an initial beamforming matrix based on the predefined number of beams; and means for determining a target beamforming matrix by an orthogonalization of beamforming vectors in the initial beamforming matrix.

In some example embodiments, an apparatus capable of performing the method 800 (for example, implemented at the terminal device 110) may include means for performing the respective steps of the method 800. The means may be implemented in any suitable form. For example, the means may be implemented in a circuitry or software module.

In some example embodiments, the apparatus comprises means for receiving a transmission from a network device by using a target beamforming matrix, wherein the target beamforming matrix is determined at least based on a predefined number of beams selected from one or more beam sets constructed based on a channel covariance matrix and at least one signature vector, and wherein the at least one signature vector characterizes features of a signal associated with the apparatus.

In some example embodiments, the apparatus further comprises means for transmitting an SRS to the network device.

In some example embodiments, the apparatus further comprises means for receiving a SSB or a CSI-RS from the network device; and means for transmitting, to the network device, beam feedback determined based on a detection of the SSB or the CSI-RS.

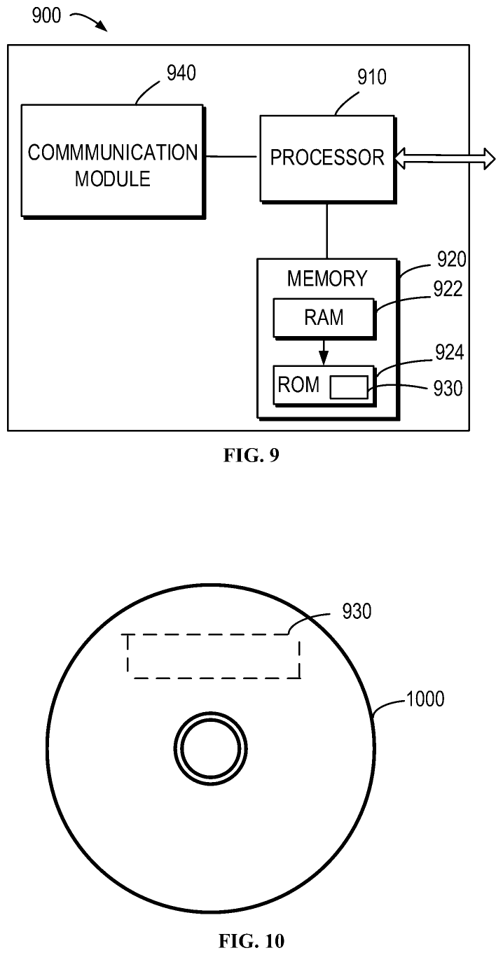

FIG. 9 is a simplified block diagram of a device 900 that is suitable for implementing example embodiments of the present disclosure. The device 900 may be provided to implement a communication device, for example, the terminal device 110 or the network device 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 640 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 900 which may be in form of CD, DVD or other optical storage disk. The computer readable medium 900 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
determine a channel covariance matrix and at least one signature vector, the at least one signature vector characterizing features of a signal associated with the terminal device;
construct one or more beam sets based on the channel covariance matrix and the at least one signature vector;
select a predefined number of beams from the one or more beam sets; and
perform a transmission to the terminal device based on a target beamforming matrix determined at least based on the predefined number of beams.

2. The apparatus of claim 1, wherein the apparatus is caused to:
determine a mode for determining the at least one signature vector based on at least one of:
whether the terminal device is able to feedback grid-of-beam, GoB, beams in time; or
whether reference signal resources are sufficient.

3. The apparatus of claim 1, wherein the apparatus is caused to:
determine the channel covariance matrix based on a sounding reference signal transmitted from the terminal device; and
determine the at least one signature vector based on at least one of:
a sounding reference signal transmitted from the terminal device; or
a beam feedback determined by the terminal device based on a detection of a synchronization signal block or a channel state information reference signal transmitted from the apparatus.

4. The apparatus of claim 1, wherein the number of one or more beam sets is associated with the number of determined at least one signature vector.

5. The apparatus of claim 1, wherein the number of basis vectors comprised in the one or more beam sets equals to or is more than the predefined number of beams.

6. The apparatus of claim 1, wherein the apparatus is further caused to:
determine beamforming basis vectors comprised in the one or more beam sets based on a Euclidean or a Chordal distance between two adjacent beamforming basis vectors.

7. The apparatus of claim 1, wherein the apparatus is further caused to:
select the predefined number of beams from the one or more beam sets based on respective powers of the channel covariance matrix represented by beamforming basis vectors comprised in the one or more beam sets.

8. The apparatus of claim 1, wherein the apparatus is further caused to:
determine an initial beamforming matrix based on the predefined number of beams; and
determine a target beamforming matrix by an orthogonalization of beamforming vectors in the initial beamforming matrix.

9. An apparatus comprising:
at least one processor; and
at least one memory storing instructions that, when executed by the at least one processor, cause the apparatus at least to:
receive a transmission from a network device by using a target beamforming matrix, wherein the target beamforming matrix is determined at least based on a predefined number of beams selected from one or more beam sets constructed based on a channel covariance matrix and at least one signature vector, and wherein the at least one signature vector characterizes features of a signal associated with the apparatus.

10. The apparatus of claim 9, wherein the apparatus is caused to:
transmit a sounding reference signal to the network device.

11. The apparatus of claim 9, wherein the apparatus is caused to:
receive a synchronization signal block or a channel state information reference signal from the network device; and
transmit, to the network device, a beam feedback determined based on a detection of the synchronization signal block or the channel state information reference signal.

12. A method comprising:
determining, at a network device, a channel covariance matrix and at least one signature vector, the at least one signature vector characterizing features of a signal associated with the terminal device;
constructing one or more beam sets based on the channel covariance matrix and the at least one signature vector;
selecting a predefined number of beams from the one or more beam sets; and
performing a transmission to the terminal device based on a target beamforming matrix determined at least based on the predefined number of beams.

13-15. (canceled)

16. A computer readable medium comprising instructions stored thereon for causing an apparatus at least to perform the method of claim 12.
